(19) United States
(12) Patent Application Publication
(10) Pub. No.: US 2026/0200611 A1
(43) Pub. Date: Jul. 16, 2026

(54) Combined Transport and Takeoff/Landing Platform Apparatus for Aerial Drones

(71) Applicant: PhiBer Manufacturing Inc., Crystal City (CA)

(72) Inventors: Derek James Friesen, Crystal City (CA); Harvey George Bergen, Crystal City (CA); Ryan Stephen Barbour, Pilot Mound (CA); Sean David Chevalier, Clearwater (CA); Peter Wall, Cartwright (CA); Ryan Clinton Henderson, Manitou (CA); Charles William Calcott, Cartwright (CA)

(21) Appl. No.: 19/022,181

(22) Filed: Jan. 15, 2025

(51) Int. Cl. B64U 70/93

(52) U.S. Cl. CPC B64U 70/93

(57) ABSTRACT

A multi-level trailer for transporting drones has a lower deck installed atop the trailer frame for hosting supplies and equipment for filling of the drones, and an upper deck that forms part of an elevated takeoff/landing platform and doubles as a roof covering of the lower deck. A set of foldable wall panels coupled to the upper deck are movable between unfolded positions expanding the upper deck to form an enlarged takeoff/landing platform in a field mode of the trailer, and folded positions forming an enclosed shelter atop the upper deck in a road transport mode. A foldable stairway is stored inside the enclosed shelter in transport mode, and deployed off to one side of the upper deck in field mode. An openable/closeable operator station with a raiseable roof resides at one end of the upper deck, and closes a respective end of the shelter in transport mode.

### FIELD OF THE INVENTION

The present invention relates generally to agricultural equipment, and more particularly for towable trailers used both for roadway transportation of aerial sprayer drones to and from field sites, and to serve as a takeoff/landing platform for the aerial drones at such field sites.

### BACKGROUND

Given a recent popularity rise in the use of aerial drones for spraying of agricultural fields, a new emergence in the agricultural equipment industry has the been the manufacture and commercialization of dual-purpose drone trailers that are useful both for the transport of aerial sprayer drones, and associated chemical supplies and equipment, to and from fields sites where agricultural chemicals are to be applied, and to serve, once parked in the field, as a stable, flat and somewhat elevated takeoff/landing platform from which such aerial sprayer drones can take-off and subsequently land. A number of double-decker drone trailers have entered the marketplace for such purpose, which double-decker designs have a lower deck residing at a lower base level of the trailer for the purpose of chemical storage and hosting of associated pumping, mixing and filling equipment, and electrical generators for electrical operation of such equipment and charging of drone batteries. An upper deck residing at an upper platform level of the double decker trailer serves as a takeoff/landing platform from which the aerial sprayer drones can take-off and land. In some designs, the lower base level also hosts an enclosure in which one or two drones can typically be stored during road travel to and from the field site. In some designs, the upper platform level includes foldable expansion wings that, when deployed, expand the available surface area of the takeoff/landing platform.

That said, the existing product offerings in this space have some shortcomings, among which are included the inconvenience of having to move the drone(s) between the two levels when transitioning from field mode to road transport mode, limited drone storage capacity owing to shared occupation of the lower base level by both the drone storage enclosure and the chemical storage, mechanical and electrical equipment, and limited selection for access to the upper platform level between either a vertical ladder running up the side of the trailer or a sloped stairway that runs up through the upper deck. Of these two typical access options, the vertical ladder is more awkward or challenging to ascend and descend, while the sloped stairway penetrating the upper deck sacrifices useable floor/platform surface area at the upper platform level.

Accordingly, there remains notable room for improved design of these double-decker drone trailers, in response to which Applicant has developed the novel and inventive double-decker drone trailer design that is the subject of the following disclosure.

### SUMMARY OF THE INVENTION

According to a first aspect of the invention, there is provided a combined transport and takeoff/landing platform apparatus for aerial drones, said apparatus comprising:

an elongated mobile frame equipped with ground wheels by which said elongated mobile frame is configured for rolling road transport;

a multi-level structure atop said elongated mobile frame, said structure comprising:

a base level having a lower deck installed atop the elongated mobile frame for hosting supplies and equipment for filling of said aerial drones;

a platform level having an upper deck supported on the elongated mobile frame in elevated and overhead relationship to said lower deck, which upper deck doubles as a roof covering of said base level; and

a set of foldable wall panels movably coupled to the upper deck along perimeter edges thereof and movable between an unfolded open state in which said foldable wall panels form outward extensions of the upper deck by which the upper deck is converted into an enlarged takeoff/landing platform, and a folded closed state in which said foldable wall panels form walls of an enclosed shelter atop the upper deck that is of lesser footprint than the enlarged takeoff/landing platform.

According to a second aspect of the invention, there is provided a combined transport and takeoff/landing platform apparatus for aerial drones, said apparatus comprising:

an elongated mobile frame equipped with ground wheels by which said elongated mobile frame is configured for rolling road transport;

a takeoff/landing deck supported on the elongated mobile frame;

a set of foldable wall panels movably coupled to the takeoff/landing deck along perimeter edges thereof and movable between an unfolded open state in which said foldable wall panels form outward extensions of the takeoff/landing deck by which the takeoff/landing deck is converted into an enlarged takeoff/landing platform, and a folded closed state in which said foldable wall panels form walls of an enclosed shelter atop the takeoff/landing deck that is of lesser footprint than the enlarged takeoff/landing platform; and

a walled operator station situated at one end of the takeoff/landing deck in a manner serving to close off a respective end of the enclosed shelter when formed in said folded closed state of the foldable wall panels.

According to a third aspect of the invention, there is provided a combined transport and takeoff/landing platform apparatus for aerial drones, said apparatus comprising:

an elongated mobile frame equipped with ground wheels by which said elongated mobile frame is configured for rolling road transport;

a takeoff/landing deck supported on the elongated mobile frame; and

a sheltered operator station situated beyond one end of the takeoff/landing deck and convertible between an enclosed state for transport and an open state for field use.

### BRIEF DESCRIPTION OF THE DRAWINGS

Preferred embodiments of the invention will now be described in conjunction with the accompanying drawings in which:

FIG. 1 is a top front left perspective view of novel sprayer drone trailer of the present invention in a folded transport mode thereof characterized by formation of an enclosed drone storage shelter at an upper platform level of the trailer.

FIG. 2 is a top rear right perspective view of the sprayer drone trailer of FIG. 1, again in the folded transport mode thereof.

FIG. 3 is a top front left perspective view of the sprayer drone trailer of FIG. 1, this time in an unfolded field mode thereof with foldable walls of the drone storage shelter unfolded to form coplanar extensions of an upper deck of the trailer for cooperative formation of an enlarged takeoff/landing platform.

FIG. 4 is a top rear right perspective view of the sprayer drone trailer of FIG. 3, again in the unfolded field mode thereof.

FIG. 5 is a partial top rear left perspective view of the sprayer drone trailer of FIG. 1.

FIG. 6 is a partial bottom rear left perspective view of the sprayer drone trailer of FIG. 1.

FIG. 7 is a top rear left perspective view of the sprayer drone trailer of FIG. 3 hosting a fleet of sprayer drones on the enlarged takeoff/landing platform.

FIG. 8 is a partial perspective view of a variant of the sprayer drone trailer, differing only in its actuator setup for raising and lowering a movable roof of its operator station.

### DETAILED DESCRIPTION

As briefly summarized above, the appended drawings illustrate one preferred embodiment of a combined transport trailer and takeoff/landing platform for aerial sprayer drones that are used to apply chemical spray to agricultural fields. This inventive apparatus is also referred to herein simply as a drone trailer 10, for brevity. The drone trailer 10 features a horizontally elongated mobile frame 12 equipped at a front section 12A thereof with a vehicle connection 14 for coupling to a tow vehicle (not shown), and equipped at a rear section 12B with a set of ground wheels 16 by which said elongated mobile frame is configured for rolling road transport when coupled to, and towed by, the tow vehicle. The drone trailer 10 is of a double-decker configuration, thus hosting a dual-level structure atop said elongated mobile frame 12. The dual-level structure includes a lower base level 18A having a lower deck 20A installed directly atop the mobile frame 12 for hosting various consumables and equipment for preparation of a chemical spray, pumped filling of sprayer drones on the upper deck with such chemical spray, electrical powering of such equipment, and electrical charging of the sprayer drones. While the trailer is described primarily in the context of sprayer drones filled with liquid product for sprayed treatment of agricultural fields, aerial drones can also be used to apply granular substances (seed, fertilizer, etc.) to such fields, in which case the liquid pumping equipment can be replaced with granular conveyance equipment for (e.g. pneumatic) conveyance of such granular substances from the lower deck to the upper deck for filling of such seeding/fertilizing drones.. The dual-level structure also includes an upper platform level 18B having an upper deck 20B supported on the elongated mobile frame in elevated and overhead relationship to the lower deck. This upper deck 20B doubles as a roof covering that provides sheltered overhead protection to the various supplies and equipment hosted on the lower deck 20A. The upper deck 20B and an associated framework thereof are supported overhead of the lower deck 20A and base frame 12 by a plurality of upright posts distributed at spaced intervals along the base frame 12 at each outer side thereof, and may supplemented with diagonal bracing between some pairs of adjacent posts, as shown in the illustrated example.

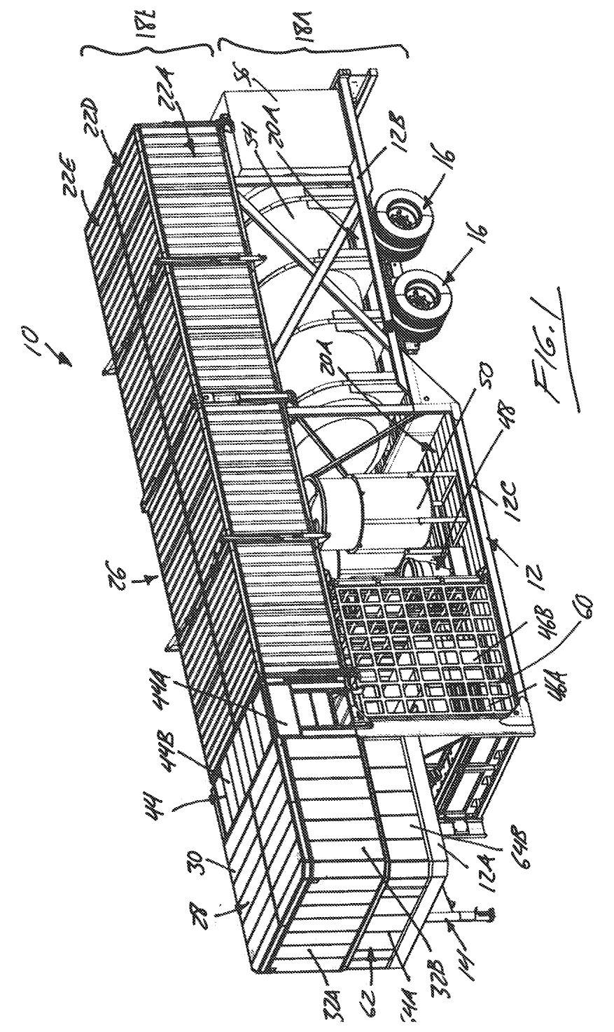

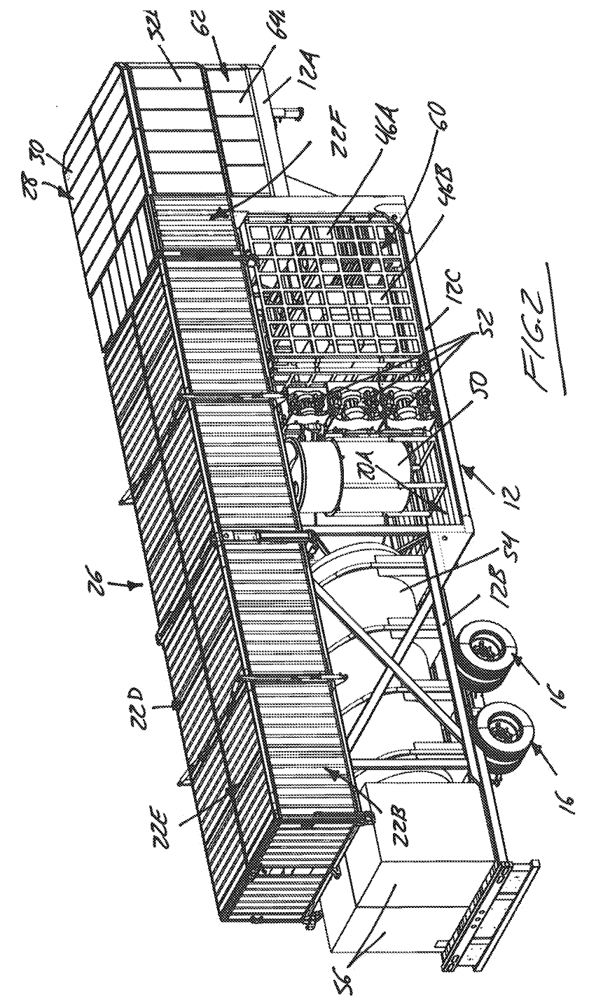

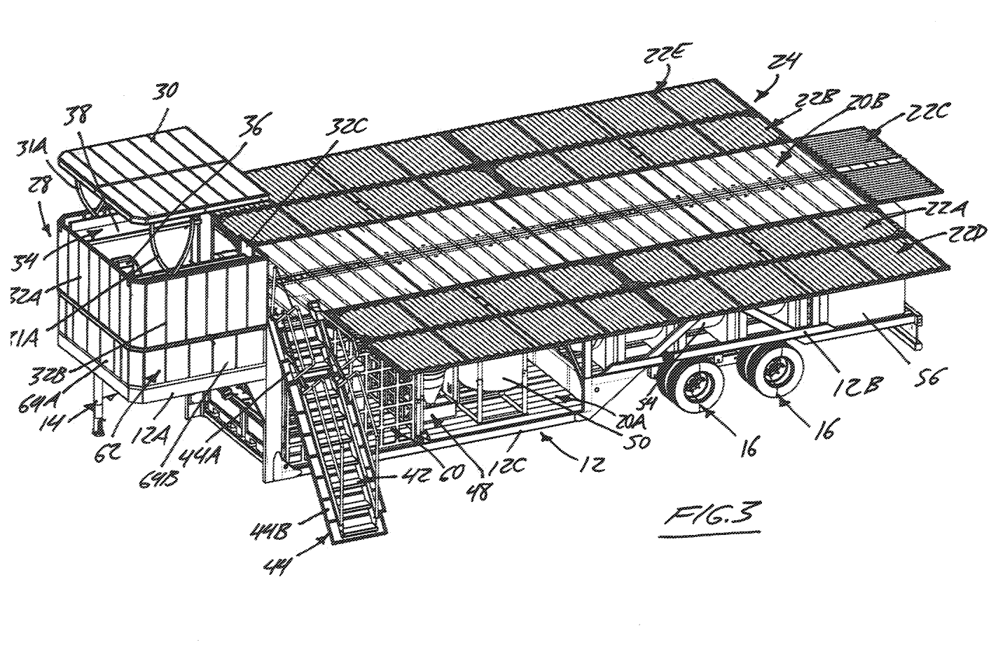

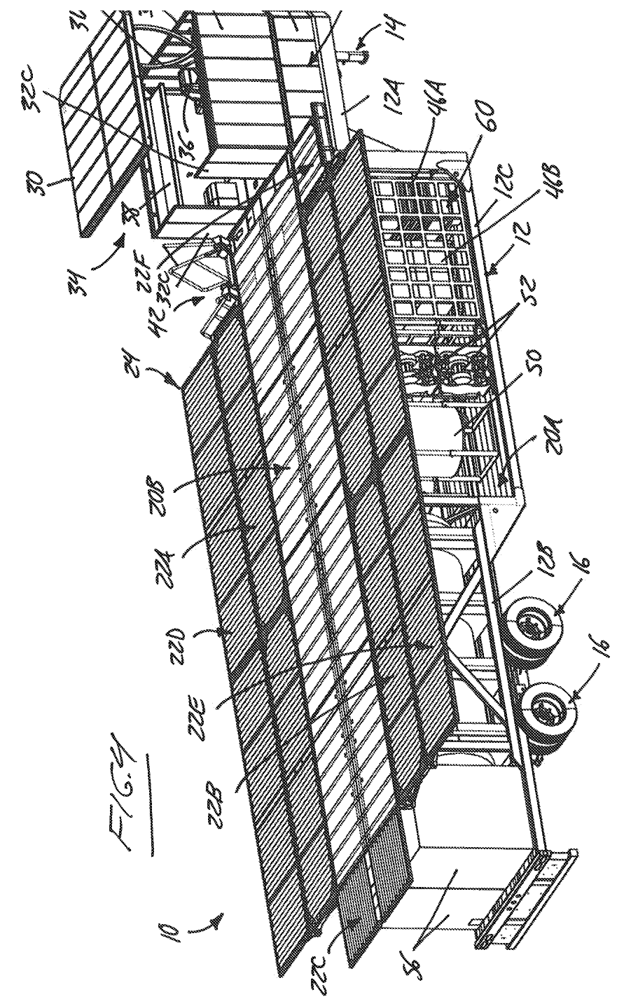

A set of foldable wall panels 22A-22E are movably coupled to the upper deck 20B along perimeter edges thereof and are movable between an unfolded open state shown in FIGS. 3 to 8, and a folded closed state shown in FIGS. 1 and 2. In the unfolded open state, the foldable wall panels 22A-22E form outward extensions of the upper deck 20B by which the upper deck 20B is converted into an enlarged takeoff/landing platform 24 of greater footprint than the upper deck 20B itself. In the folded closed state, the foldable wall panels 22A-22E instead cooperatively form walls and roof sections of an enclosed shelter 26 formed atop the upper deck 20B, the latter of which denotes the floor of this enclosed shelter 26 when so formed by the closure of the foldable wall panels. This enclosed shelter 26 is characterized by a lesser footprint (denoted by the upper deck 20B alone) than the enlarged takeoff/landing platform (collectively defined by the upper deck and foldable wall panels) in the open state. The folded closed state of the foldable wall panels 22A-22E corresponds to a folded transport state of the trailer 10 as a whole, which state is occupied thereby during road travel, during which one or more sprayer drones are safely stored inside the enclosed shelter 26, ensuring safe retention of the sprayer drones on the trailer 10 and protection thereof from the elements, as well as providing protection against theft or tampering when the trailer 10 is parked somewhere in this folded closed state. The upper deck 20B doubles as both the floor of this enclosed shelter 26 in the folded transport mode, and a middle section of the enlarged takeoff/landing platform 24 in the unfolded field mode. By providing sheltered storage of the sprayer drone(s) on the upper deck 20B in the folded closed transport mode, there is no need to transition the drones between the upper platform level and the lower base level in order to switch between field use of the trailer 10 for takeoff and landing of the sprayer drone(s), and road use of the trailer to transport the drone(s) to and from a field site.

The illustrated embodiment of the trailer 10 is further characterized by inclusion of an elevated operator station 28 residing at a closer elevation to the upper deck 20B than to the lower deck 20B, and more particularly at a matching elevation to the upper deck 20B in the illustrated example. In the illustrated example, the floor 28A of the operator station 28 is a coplanar and longitudinally inline extension of the upper deck 20B at a front end thereof, whereby one or more human operators can easy transition back and forth between the operator station and the upper deck 20B with no intervening stair(s), step(s) or ladder. It will be appreciated that longitudinal directionality is used herein to refer to a horizontal directionality in which the mobile frame 12 of the trailer 10 is elongated, in which the front and rear sections 12A, 12B of the trailer are spaced apart and in which the trailer travels when towed, in contrast to a lateral directionality that refers a horizontal directionality of perpendicular relationship to the longitudinal directionality. The operator station 28 is convertible between an enclosed state in the folded transport mode of the trailer 10, and an open state in the unfolded field mode 10 of the trailer. The elevated operator station 28 possess a greater occupational height in its open state than in its enclosed state, so that the overall height profile of the trailer 10 is lower in the folded transport mode than in the unfolded field mode.

The illustrated example of the openable/closable operator station 28 comprises a movable roof 30 configured for movement between a raised position occupied in the open state of the operator station 28, and a lowered position occupied in the enclosed state of the operator station 28. The operator station 28 is vertically walled at front and lateral sides thereof by solidly-cladded front and lateral station walls 32A, 32B, which are typically permanent walls of statically fixed position and orientation, thus providing permanent fall protection around these three sides of the operator station’s perimeter. Th raised position of the movable roof 30 opens up empty window spaces 34 between the raised roof 30 and the front and lateral station walls 32A, 32B, thus denoting the open state of the operator station 28 in which human occupants of the operator station 28 can view the aerial environment around the trailer through these opened window spaces 34 in order to have sightlines to the aerial drones during flight. The raised position of the movable roof 30 is elevationally high enough to accommodate standing occupancy of the operator station 28, though the operator station 28 is preferably also occupied by one or more operator seats 36 (e.g. chairs, stools, benches, or any combination thereof) and one or more associated working surfaces 38 (countertop, desktop, tabletop, shelf, or any combinations thereof) of elevated relation to the operator station floor 28A. This way, the drone operator(s) can occupy comfortably seated working positions with aerial sightlines through the open window spaces 34, while benefiting from shaded and sheltered protection under the raised movable roof 30, which sheltered roof coverage shields the operator(s) not only from rainfall, but also provides a robust safety barrier against potential airborne drone accidents, owing to a solidly-cladded rigid-panel construction of the movable roof 30.

In furtherance of such protection of any occupant(s) of the operator station from exposure to moving parts of the drones, when situated on the upper deck, the illustrated example of the operator station has solidly-cladded rear station walls 32C standing upright on either side of an entrance/exit of the operator station at the front end of the upper deck as another protective barrier of rigid construction. An openable/closeable door or gate may be included at this entrance/exit of the operator station to enable closure thereof behind the operator station occupant(s) for even greater operator safety behind such closed door or gate. The illustrated operator station with its solidly-cladded and rigid walls and roof thus provides much greater operator safety, both in terms of fall prevention and drone safety, than a more “soft walled” shelter like an erectable/collapsible fabric canopy roof, or an operator area bordered by skeletal fall-protection rails that are not solidly cladded.

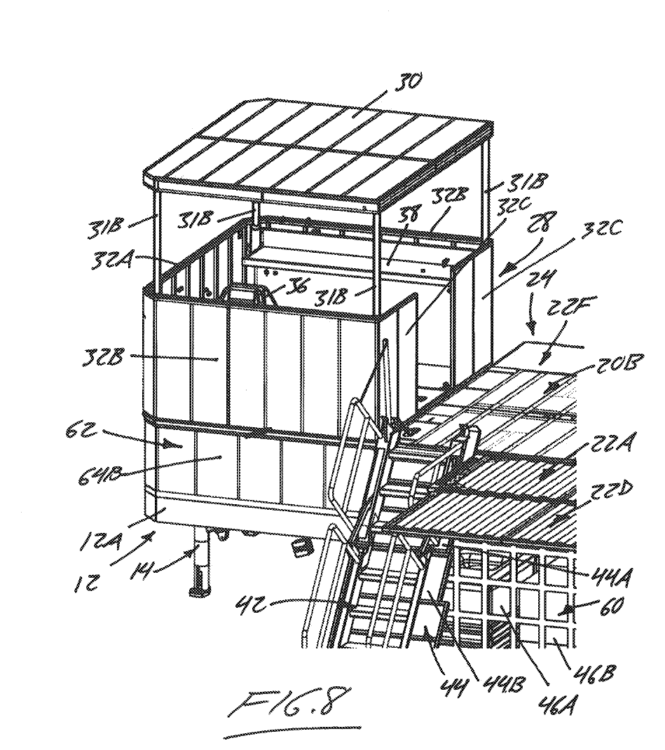

In the illustrated embodiment, the movable roof 30 of the operator station 28, in the lowered state thereof corresponding to closure of the operator station 28, neighbours a closed roof of the enclosed shelter 26 when the foldable wall panels 22A-22E of the shelter 26 are folded closed. More particularly, the lowered movable roof 30 of the operator station 28 resides longitudinally inline and coplanar with the closed roof of the enclosed shelter 26 when the foldable shelter walls are in the closed state, with the result that an overall roofline of the trailer in the folded closed transport mode is an effectively continuous surface spanning a full length of the trailer 10. Positioned at the front end of the enclosed shelter 26, the operator station 28 serves to enclose this front end of the enclosed shelter 26 in the folded closed state of the trailer 10. In FIGS. 1 to 7, the movable roof is lifted and lowered via two scissor linkages 31A at opposing lateral sides of the operator station 28, whereas the variant in FIG. 8 instead employs a set of four linear actuators 31B standing upright at the four corners of the square or rectangular operating station 28 to actuate the lifting and lowering of the movable roof 30 in transition between the transport and field modes of the drone trailer 10.

The drone trailer 10 features a foldable access stairway 42 movable between a transport position stored within the enclosed shelter (FIGS. 1 and 2) and a working position (FIGS. 1 to 8) spanning downward from the upper deck 20B toward ground level for user-ascension to the upper deck 20B from ground level via said access stairway. The access stairway 42 is hosted on a foldable wall section 44 that is movable between a folded state corresponding to the transport position of the stairway 42, and an unfolded stated corresponding to the working position of the stairway 42. In its folded state, the foldable wall section 44 cooperates with the foldable wall panels 22A-22E in collective formation of the enclosed shelter 26 atop the upper deck 20B. In the illustrated embodiment, the stairway-hosting foldable wall section 44 resides between the operator station 28 and the foldable wall panels 22A-22E in the longitudinal directionality of the trailer 10, so that when the stairway-hosting foldable wall section 44 is unfolded, the deployed access stairway 42 provides shared and direct access, from ground level, to both of the upper deck 20B and the operator station 28 at the front end of the enlarged takeoff/landing platform 24. That said, an access stairway hosted by a movable wall section 44 of the enclosed shelter 26 could alternatively be hosted at alternative locations somewhere along either side of the drone trailer 10, at the rear end thereof, or even at the front end of the drone trailer, whether such front stairway be incorporated into a foldable wall section of modified version of the operator station, or incorporated into a modified version of the shelter in embodiments lacking an operator station at the front end thereof.

In the illustrated embodiment, the mobile frame 12 of the trailer 10 is a gooseneck trailer frame whose front section 12A is configured as a raised gooseneck section that is unoccupied by the lower deck 20A. The lower deck 20A of the illustrated example is hosted by the rear section 12B and an intervening middle section 12C of the frame that resides between the front and rear sections 12A, 12B thereof. In the illustrated example, the mobile frame 12 of the trailer 10 is a double-drop gooseneck trailer frame, where the middle section 12C is elevationally distinct from the rear section 12B, residing at a lower elevation than the wheel-hosting rear section 12B. dropped middle section 12C provides easier operator access from ground level to the lower deck 20A at the middle section 12C, and also creates an elevationally taller occupational height of the lower deck 20B at this middle section 12C than at the rear section 12C, thus enabling hosting of taller equipment at the middle section 12C and greater standing room for human operators at this middle section 12C.

For this reason, the illustrated embodiment hosts supplies and equipment requiring or involving the most human interaction therewith at the middle section 12C of the trailer, such as chemical supply containers 46A, 46B, one or more mixing stations 48 each having a mixing vessel for mixing stored chemical from the supply containers with water to formulate the spray mixture, one or more batching tanks 50 for holding prepared batches of the spray mixture, and pumps 52 for pumping of the formulated spray mixture from the mixing station 48 to the batching tanks 50 and onward from there to the upper deck 20B for filling of the sprayer drones with the formulated spray mixture via one or more flexible filling hoses (not shown). Hosted on the higher rear section 12C of the frame 12 are one or more water storage tanks 54 of notably greater capacity than the batching tank(s) 50, and one or more generators 56 for generating electrical power to run the other various equipment, and also provide an electrical source for one or more batteries from which the sprayer drone(s) can be charged. The smaller batching tanks 50 hosted at the middle section 12C stand upright in generally vertical orientation, whereas the larger water tank(s) 54 hosted at the rear section 12 is/are laid down in a generally horizontal orientation running longitudinally of the trailer 10. As shown, the lower deck 20A may host a caged or fenced storage area 60, in the illustrated example at a front segment of the middle section 12C, where the chemical supply containers 46A, 26B are securely stored, while the mixing station 48 instead resides outside the caged/fenced storage area 60 at a rear segment of the middle section 12C for optimally convenient access to the mixing station 48 outside the fenced/caged storage area 60.

In the illustrated embodiment, where the floor 28A of the operator station 28 is coplanar with the upper deck 20A, yet the front gooseneck section 12A of the frame 12 resides at an intermediate elevation of greater elevation than the lower deck 20A but lesser elevation than the upper deck 20B, the space bound elevationally between the front gooseneck section 12A of the mobile frame 12 and the floor 28A of the operator station 28 may be employed as a sheltered storage space 62, and is therefore closed off at front and lateral sides thereof in the illustrated example by front and lateral storage walls 64A, 64B, each residing vertically adjacent a respective one of the front and lateral station walls of the overlying operator station 28. A floor of this shelter space is hosted atop the front gooseneck section 12A of the mobile frame 12 of the trailer 10, and a rear end of this shelter space may be permanently open for access thereto (from the fenced/caged storage area 60 of the illustrated example), or equipped with a selectively openable and closeable access door for selective access to the sheltered storage space 62 when opened, yet providing full enclosure of this sheltered storage space 62 when closed.

Though different styles of folding pattern may be employed to similar purpose and effect, further attention is now given to one workable setup for the foldable wall panels 22A-22E and cooperating foldable wall section 44 of the formable enclosed shelter 26 at the upper platform level 18B of the trailer 10. The illustrated example features a first rectangular sidewall panel 22A and a second rectangular sidewall panel 22B each running along, and hinged to, a respective one of two matching long sides of the rectangular upper deck 20B, and a rectangular end-wall panel 22C that runs along, and is hinged to, a rear end of the upper deck 20B that runs laterally between the two longs sides of the upper deck 20B at a rear terminus thereof. The foldable wall panels 22A-22E further include a first rectangular roof-wall panel 22D hinged to the first sidewall panel 22A along an outside edge thereof that lies opposite of and parallel to the respective long side of the upper deck 20B to which that first sidewall panel 22A is hinged, and a matching second rectangular roof-wall panel 22E hinged to the second sidewall panel 22B along an outside edge thereof that lies opposite of and parallel to the respective long side of the upper deck 20B to which that second sidewall panel 22B is hinged. Roof panel 22D runs the full length of the sidewall panel 22A to it is hinged. In the illustrated embodiment with a foldable stairway hosted by a foldable wall section that folds separately of the foldable wall panels 22A-22E, roof panel 22E, while being the same length as roof panel 22D, is slightly shorter than the sidewall panel 22B to which roof panel 22E is hinged, which sidewall panel 22B is slightly longer than the opposing sidewall panel 22A, owing to a manner in which the foldable wall panels and the stairway-hosting foldable wall section fold up together in the folded closed state of the drone trailer 10. In other embodiments lacking the foldable stairway, or employing a different location or folding pattern thereof, the two sidewall panels 22A, 22B may be of equal size, as may be the two roof panels 22D, 22E.

In the folded closed state of the foldable wall panels 22A-22E, the two sidewall panels 22A, 22B stand erect from the plane of the upper deck 20B at the respective long sides thereof, and the two roof-wall panels 22D, 22E span laterally inward from the top ends of the erected sidewall panels 22A, 22B to meet with one another at a midplane of vertical and longitudinal orientation that longitudinally bisects the trailer 10 into two lateral halves, whereby the two meeting roof-wall panels 22D, 22E cooperatively form the closed roof of the enclosed shelter 26. In the unfolded open state of the foldable wall panels 22A-22E, the two roof-wall panels 22D, 22E lie coplanar with the two sidewall panels 22A, 22B at the outside edges thereof, and thus also coplanar with the upper deck 20B, whereby the unfolded sidewall and roof panels form lateral extensions of the upper deck 20B. The end-wall panel 22C lies coplanar to the upper deck 20B at the rear end thereof in the unfolded open state of the foldable wall panels 22A-22E to form a rearward extension of the upper deck 20B, and stands erect of the upper deck from the plane of the upper deck 20B at the rear end thereof in the folded closed state of the foldable wall panels 22A-22E. In the erect position, the end-wall 22C thus spans between the upright rear ends of the two erect sidewalls 22A, 22B and thereby closes off the rear end of the enclosed shelter 26.

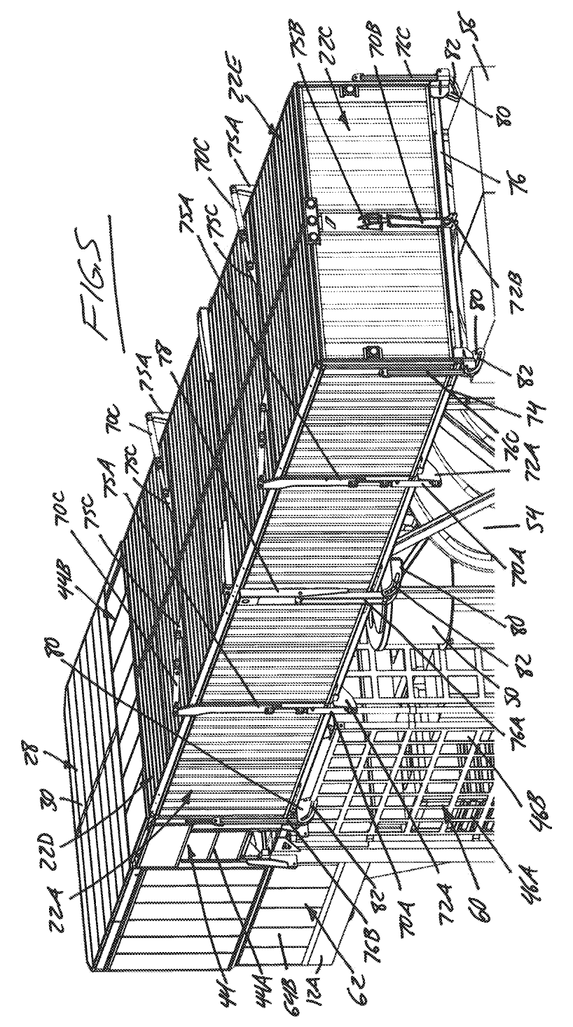

With reference to FIG. 5, each sidewall 22A, 22B is equipped with at least one sidewall actuator 70A, and more particularly two thereof in the illustrated example, for actuating movement of the sidewall between its open and closed positions of coplanar and erect relationship, respectively, to the upper deck 20B. In the illustrated example, each such sidewall actuator 70A is a linear actuator having one end pinned to a first mounting bracket 72A affixed to a longitudinal outer frame rail 74 of the upper deck’s supportive framework, and another end pinned to a second mounting bracket 75A affixed to the sidewall panel 22A, 22B at an external face thereof that faces outwardly of the enclosed shelter 26 in the formed state thereof, and faces downwardly of the enlarged takeoff/landing platform 24 in the formed state thereof. Expansion of the sidewall actuators 70A moves the sidewall panels 20A, 20B into their erect shelter-forming closed positions, and collapse of the sidewall actuators 70A moves the sidewall panels 20A, 20B into their outwardly spanning platform-enlarging open positions. End-wall panel 22C likewise is equipped with at least one end-wall actuator 70B, again typically in the form of a linear actuator, which end-wall actuator 70B similarly has one end pinned to a first mounting bracket 72B on a terminal frame rail 76 of the upper deck’s supportive framework, and another end pinned to a second mounting bracket 75B affixed to the end-wall panel 22C at the external face thereof, for movement of the end-wall panel 22C in equivalent fashion to the sidewall panels.

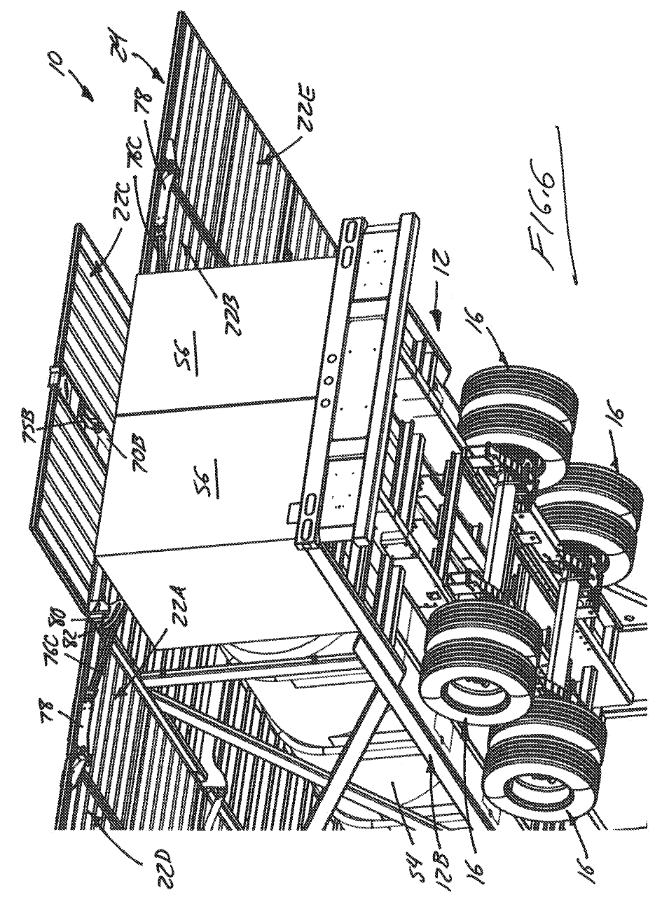

As shown in the illustrated example, each sidewall 22A, 22B may be further braced and constrained by a set of stabilizer arms 76A, 76B, 76C, of which there are three in the illustrated example, namely a central stabilizer arm 76A at a generally central region of the sidewall’s length, and a pair of outer stabilizer arms 76B, 76C respectively disposed at front and rear ends of the sidewall 22A, 22B. Each stabilizer arm has one end pinned to a coupling bracket 78 (FIG. 6) on the exterior face of the sidewall panel 22A, 22B, and another end pinned to a guide bracket 80 on the longitudinal outer frame rail 74 in a curved guide slot 82 of this guide bracket 80. In this slot 82, the respective end of the stabilizer arm can move back and forth under expansion and collapse of the respective set of sidewall actuators 70A. The stabilizer arms 76A-76C help synchronize the movement of the relatively large sidewall panels 22A, 22B over the notable length thereof, and help resist/prevent tilting and deflection of these relatively large sidewall panels, whereas the notably smaller end-wall panel 22C may not require such additional support and stabilization, hence lacking any equivalent or comparable stabilizers for the end-wall panel 22C in the illustrated embodiment.

In the outwardly spanning platform-enlarging open positions, the sidewall panels 22A, 22B are held in place by mechanical stops, in the illustrated example embodied by at least one of either bottoming out of the sidewall cylinders 70A in their fully collapsed positions, and/or bottoming out of the stabilizer arms at the inside lower ends of the guide slots 82 in the guide brackets 82. By inclusion of such integrated mechanical stops into the trailer design, ground support legs need not be installed beneath the outlying sidewall and roof-wall panels to bear the weight thereof from ground level.

Referring again to FIG. 5, each roof panel 22D, 22E is movable relative to the respective sidewall panel 22A, 22B to which it is hinged by at least one, and in the illustrated example two, roof actuators 70C, each having one end pinned to a mounting bracket on the external face of the respective sidewall panel 22A, 22B, for example at a second end of the same mounting bracket 75A to which one of the sidewall actuators 70A is pinned at a first end thereof. The other end of each roof actuator 70C is pinned to another mounting bracket 75C affixed to the roof panel 22D, 22DE at the external face thereof that faces upwardly in the folded closed state of these roof panels and downwardly in the unfolded open state thereof. Via expansion and collapse of these roof actuators 70B, the roof panels 22D, 22E are movable about their respectively hinged connections to the sidewall panel 22A, 22B between the folded and unfolded positions of the roof panel 22D, 22E.

The stairway-carrying foldable wall section 44 comprises a sidewall segment 44A that is hinged to the same long side of the upper deck 20B as the sidewall panel 22A. In the folded state of the foldable wall section 44, this sidewall segment 44A occupies an erect position residing in-line with the sidewall panel 22A in parallel and coplanar relation thereto, so that the sidewall panel 22A and sidewall segment 44A collectively span an entirety of this long side of the upper deck 20B to form an overall sidewall span of the enclosed shelter 26 that runs from the operator station 28 to the erected end-wall panel 22C. The erected sidewall segment 44A spans the gap between the front end of the erected sidewall panel 22A and the rear end of the respective lateral station wall 32B, which resides coplanar with the erected sidewall segment 44A and respectively erected sidewall panel 22A, so that the sidewall span of the enclosed structure 26 and the respective lateral station wall 32B collectively span the full length of the trailer 10.

The stairway-carrying foldable wall section 44 also comprises a roof segment 44B that is hinged to the sidewall segment 44A at an outer end thereof opposite its hinged connection to the long side of the upper deck 20B. In the folded state of the foldable wall section 44, the roof segment 44B spans inwardly across the upper deck 20B in elevated relation thereover from the top end of the erected sidewall segment 44A, and resides in a horizontal orientation residing in-line with the two closed roof panels 22D, 22E in parallel and coplanar relation thereto. In this state, the roof panels 22D, 22E and the roof segment 44B collectively span over an entirety of the upper deck 20B to form an overall roof span of the enclosed shelter 26 that runs from the operator station 28 to the erected end-wall panel 22C. The folded roof segment 44B spans the gap between the front end of the folded roof panels 22D, 22E and the rear end of the lowered roof 30 of the operator station 28, which resides coplanar with the folded roof segment 44B and the two roof panels 22D, 22E, so that the roof span of the enclosed structure 26 and the lowered roof 30 of the operator station 28 collectively span the full length of the trailer 10. The two segments 44A, 44B of the foldable wall section 44 each host a respective segment of the access stairway 42. Each stairway segment features a plurality of stair treads affixed to and projecting obliquely from an interior face of the respective wall section segment, meaning the side thereof that faces into the enclosed shelter 26 when formed by folding of the foldable wall panels 22A-22E and foldable wall section 44. Each stairway segment further includes a respective pair of associate handrails likewise affixed the interior face of the respective wall section segment on opposing sides of the stair treads.

The stair treads and handrails thus all reside internally of the enclosed shelter 26 when formed, with no part of the foldable stairway 42 being external of or protrusive from the enclosed shelter 26 when formed. When deployed in the working position, the foldable stairway 42 instead extends outwardly from the long side of the upper deck 20B at a descending angle down to the ground, and thereby provides access to the upper deck from the adjacent ground area. This design avoids the need to include a manway opening the upper deck 20B that would be required for a permanent access stairway instead installed in the lower level 18A, which would reduce the useable surface area of the upper deck, or require an openable closeable trap door therein that would require opening and closing each time the stairway is traversed. Another detriment of a permanent access stairway residing within the footprints of the two decks 20A, 20B is a reduction in the available usage capacity of the lower level 18A of the trailer 10. Uniquely and beneficially, the foldable access stairway 42 only occupies internal space of the novel trailer 10 in road transport mode, and even then, occupies only a narrow cross-wise strip of the enclosed shelter 26 on the upper platform level just behind the closed operator station 28, denoting a space that is unoccupied and unused by personnel in road transport mode.

The second sidewall panel 22B on the long side of the upper deck 20B opposite that where the first sidewall panel 22A and stairway-hosting wall section 44 are installed is longer than the first sidewall panel 22A and both roof panels 22D, 22E. This way, the longer sidewall panel 22B spans all the way forward to the operator station 28 to reside inline with the corresponding lateral station wall 32B on that side of the trailer 10 when the second sidewall panel 22B is erected. This way, a frontmost segment 22F of the second sidewall panel 22B that extends beyond the front end of the corresponding roof panel 22E cooperates, when erected, with the stairway-hosting wall section 44, when folded, to close off the frontmost region of the enclosed shelter in which the folded access stairway 42 is stored.

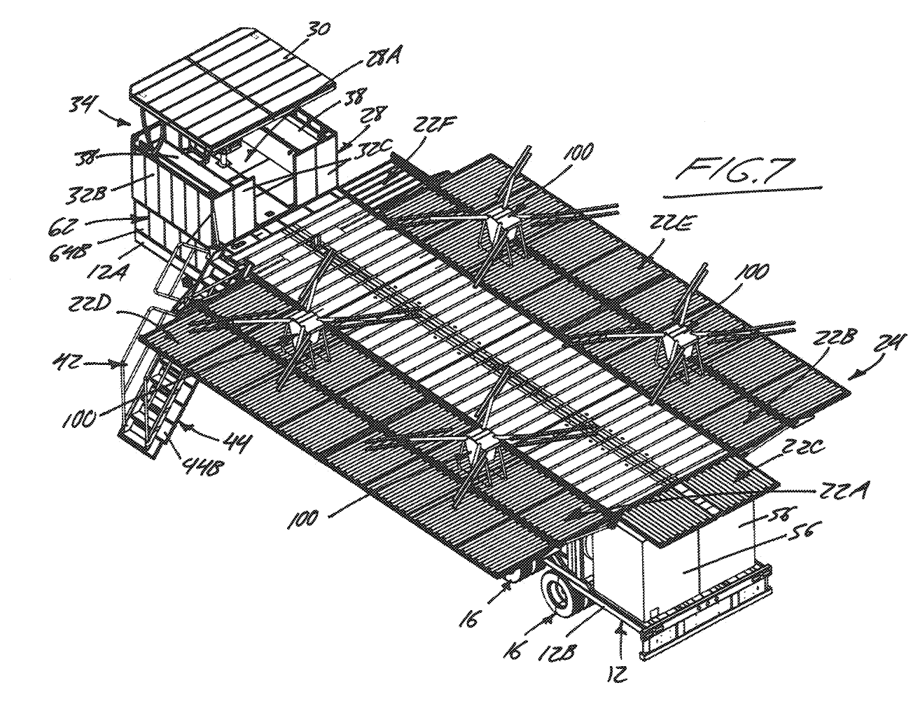

As shown in FIG. 7, the enlarged takeoff/landing platform 24 in the unfolded state of the foldable wall panels 22A-22E and the foldable wall section 44 provides dramatically greater surface area for takeoff and landing of a fleet of aerial sprayer drones 100 compared to just the upper deck 20B that forms a mid-region of the enlarged takeoff/landing platform 24. After spraying, the aerial drones 100, which may be collapsible into storage/transport states of reduced footprint, are all storable atop the upper deck 20B within the sheltered confines of the enclosed shelter 26 formed by the folded closure of the wall panels 22A-22E and stairway-hosting foldable wall section 44. There is no need to carry the drones 100 down off the upper deck or platform for road travel, and likewise no need to carry such removed drones back up to the platform for the next field use. A near entirety of the upper deck, save for a small front strip thereof occupied by the foldable access stairway 42, is available for such drone storage during travel and between field uses, denoting dramatically greater drone storage capacity than drone trailers that instead rely on storage availability at the lower level.

Since various modifications can be made in the invention as herein above described, and many apparently widely different embodiments of same made, it is intended that all matter contained in the accompanying specification shall be interpreted as illustrative only and not in a limiting sense.

1. A combined transport and takeoff/landing platform apparatus for aerial drones, said apparatus comprising:
an elongated mobile frame equipped with ground wheels by which said elongated mobile frame is configured for rolling road transport
a multi-level structure atop said elongated mobile frame, said structure comprising:
a base level having a lower deck installed atop the elongated mobile frame for hosting supplies and equipment for filling of said aerial drones;
a platform level having an upper deck supported on the elongated mobile frame in elevated and overhead relationship to said lower deck, which upper deck doubles as a roof covering of said base level; and
a set of foldable wall panels movably coupled to the upper deck along perimeter edges thereof and movable between an unfolded open state in which said foldable wall panels form outward extensions of the upper deck by which the upper deck is converted into an enlarged takeoff/landing platform, and a folded closed state in which said foldable wall panels form walls of an enclosed shelter atop the upper deck that is of lesser footprint than the enlarged takeoff/landing platform.

2. The apparatus of claim 1 further comprising an elevated operator station residing at a closer elevation to the upper deck than to the lower deck, said operator station being convertible between an enclosed state for transport and an open state for field use.

3. The apparatus of claim 2 wherein said elevated operator station is configured to possess a greater occupational height in said open state than in said enclosed state.

4. The apparatus of claim 2 wherein said elevated operator station comprises a movable roof.

5. The apparatus of claim 4 wherein said movable roof of the elevated operator station is configured for movement between a raised position, occupied in said open state of the elevated operator station, and a lowered position, occupied in said enclosed state of the elevated operator station.

6. The apparatus of claim 4 wherein the roof of the elevated operator station, in the enclosed state thereof, neighbours a roof of the enclosed shelter when the foldable shelter walls are in the closed state.

7. The apparatus of claim 6 wherein the roof of the elevated operator station, in the enclosed state thereof, resides inline with, and forms an extension of, said roof of the enclosed shelter when the foldable shelter walls are in the closed state.

8. The apparatus of claim 2 wherein a floor of the operator station runs resides inline with the upper deck at one end thereof.

9. The apparatus of claim 1 wherein the operator station serves to enclose a respective end of the enclosed shelter, when formed in of said closed state of foldable wall panels.

10. The apparatus of claim 2 wherein the elongated mobile frame is a gooseneck trailer frame with a raised gooseneck section at one end thereof, overhead of which the operator station resides, and which raised gooseneck section hosts a sheltered storage space thereatop in sheltered relation beneath a floor of the operator station.

11. The apparatus of claim 10 wherein said storage space is enclosed at front and lateral sides thereof by front and lateral walls of said sheltered storage space.

12. The apparatus of claim 11 wherein the operator station is walled at front and lateral sides thereof by front and lateral walls of said operator station that reside in respective adjacency to the front and lateral walls of the enclosed storage space.

13. The apparatus of claim 1 comprising an access stairway movable between a transport position stored within the enclosed shelter and a working position spanning downward from the upper deck toward ground level for user-ascension from ground level to the upper deck via said access stairway.

14. The apparatus of claim 13 wherein the foldable wall panels are accompanied by a foldable wall section on which said access stairway is hosted, said foldable wall section being movable between a folded state cooperating with the foldable wall panels in formation of the enclosed shelter atop the upper deck, and an unfolded state spanning downwardly from the upper deck toward ground level to place the access stairway in said working position.

15. The apparatus of claim 1 comprising an access stairway hosted on a foldable wall section that, in a folded state thereof, cooperates with foldable wall panels in formation of the enclosed shelter atop the upper deck, and in an unfolded state, spans downwardly from the upper deck toward ground level to place the access stairway in a working position that is user-ascendable to access the upper deck from ground level.

16. A combined transport and takeoff/landing platform apparatus for aerial drones, said apparatus comprising:
an elongated mobile frame equipped with ground wheels by which said elongated mobile frame is configured for rolling road transport;
a takeoff/landing deck supported on the elongated mobile frame;
a set of foldable wall panels movably coupled to the takeoff/landing deck along perimeter edges thereof and movable between an open state in which said foldable wall panels form outward extensions of the takeoff/landing deck by which the takeoff/landing deck is converted into an enlarged takeoff/landing platform, and a closed state in which said foldable wall panels form walls of an enclosed shelter atop the takeoff/landing deck that is of lesser footprint than the enlarged takeoff/landing platform; and
a walled operator station situated at one end of the takeoff/landing deck in a manner serving to close off a respective end of the enclosed shelter when formed in said folded closed state of the foldable wall panels.

17. The apparatus of claim 16 wherein said operator station is convertible between an enclosed state for transport and an open state for field use.

18. The apparatus of claim 17 wherein said operator station is configured to possess a greater occupational height in said open state than in said enclosed state.

19. The apparatus of claim 17 wherein said elevated operator station comprises a movable roof.

20. The apparatus of claim 19 wherein said movable roof of the elevated operator station is configured for movement between a raised position, occupied in said open state of the elevated operator station, and a lowered position, occupied in said enclosed state of the elevated operator station.

21. The apparatus of claim 19 wherein the roof of the elevated operator station, in the enclosed state thereof, neighbours a roof of the enclosed shelter when the foldable shelter walls are in the closed state.

22. The apparatus of claim 21 wherein the roof of the elevated operator station, in the enclosed state thereof, resides inline with, and forms an extension of, said roof of the enclosed shelter when the foldable shelter walls are in the closed state.

23. A combined transport and takeoff/landing platform apparatus for aerial drones, said apparatus comprising:
an elongated mobile frame equipped with ground wheels by which said elongated mobile frame is configured for rolling road transport;
a takeoff/landing deck supported on the elongated mobile frame; and
a sheltered operator station situated beyond one end of the takeoff/landing deck and convertible between an enclosed state for transport and an open state for field use.

24. The apparatus of claim 23 wherein said operator station is configured to possess a greater occupational height in said open state than in said enclosed state.

25. The apparatus of claim 23 wherein said elevated operator station comprises a movable roof.

26. The apparatus of claim 25 wherein said movable roof of the elevated operator station is configured for movement between a raised position, occupied in said open state of the elevated operator station, and a lowered position, occupied in said enclosed state of the elevated operator station.
